(19) United States
(12) Patent Application Publication
(10) Pub. No.: US 2010/0315680 A1
(43) Pub. Date: Dec. 16, 2010

(54) NETWORKED PRINTER SYSTEM, NETWORKED PRINTER MANAGEMENT SYSTEM, AND NETWORKED PRINTER MANAGEMENT METHOD

(76) Inventor: Satoru ISHIKAKE, Kawasaki city (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/813,934

(22) Filed: Jun. 11, 2010

(30) Foreign Application Priority Data
Jun. 12, 2009 (JP) 2009-141392

(51) Int. Cl. G06F 3/12

(52) U.S. Cl. 358/1.15

(57) ABSTRACT

A networked printer system includes one or more client machines disposed on a network, a plurality of networked printers disposed on the network and connected to the one or more client machine via the network, and an automatic switching unit disposed on the network. The automatic switching unit includes a print request receiving unit receiving a print request issued by the client machine, and a printer information acquisition unit obtaining and storing print history information of each one of the networked printers. The automatic switching unit determines one suitable printer from among the plurality of networked printers based on print data of the print request and the print history information of the networked printers, and transmits the print data issued by the client machine, to the one suitable printer.

### CROSS-REFERENCE TO RELATED APPLICATIONS

This application claims priority to Japanese Patent Application No. 2009-141392, filed on Jun. 12, 2009 in the Japan Patent Office, which is hereby incorporated by reference herein in its entirety.

### BACKGROUND OF THE INVENTION

1. Field of the Invention

The present invention relates to a networked printer system having a plurality of networked printers connected with each other via a network, and more particularly, to a method of utilizing suitable printers in view of conditions of each of the printers connected with each other via a network.

2. Description of the Background Art

A network system may be configured with one or more client machines, a printer server machine, and a plurality of networked printers, which are connected with each other via a network, for example. In such network system, a client machine selects one of the networked printers (i.e., a printer resource) to issue or instruct a print request to the selected networked printer for conducting a printing operation, initiated by activating a given application on the client machine. A user can install one or more printer drivers corresponded to each one of the networked printers in the client machine in advance so that the user can use any one of networked printers via the printer server machine and the network.

In such a configuration, although the plurality of printer drivers can be installed in the client machine, the client machine can designate only one of the printer drivers matched to a given networked printer when conducting a printing operation based on a print request. Accordingly, if an error or trouble occurs during the printing operation in the selected networked printer, the user needs to re-select another networked printer to re-transmit same print data.

Further, in the above-described system, the system architecture is such that a plurality of client machines can communicate with any one of the networked printers. Accordingly, a plurality of client machines can transmit print requests to one networked printer simultaneously to conduct printing operations. However, if an error or trouble occurs in such one networked printer during one printing operation requested by one print request from one client machine, other printing operations requested of that same printer from other client machines cannot be conducted. As a result, such plurality of print requests may be stacked and printing operations may be stopped.

Further, if a plurality of client machines transmits print requests to one networked printer simultaneously and if one print request includes a large volume of print data or complex print data that needs a longer time for printing, a printer queue of the networked printer may be occupied by such print data, by which a waiting time of printing operations as a whole becomes too long.

In view of such situation, a client machine may request a print request to a selected networked printer, disposed on a network, while checking a present condition of the selected networked printer. For example, it is checked whether the selected networked printer is in a ready-to-print condition and it is checked whether print-waiting time of the selected networked printer is to be long or short. The print-waiting time is a time period that the selected networked printer needs to wait to start a printing operation for a given print request.

If it is determined that the networked printer is not in the ready-to-print condition, or the print-waiting time is long, or a relevant printer server machine is not yet activated, another suitable networked printer that can conduct a printing operation quickly, may be automatically selected for the client machine that requests a print request for print data, in which networked printers are automatically switched so that the client machine can issue a print request to a networked printer that is ready for printing operation as described below, for example.

JP-2001-142663-A discusses a network having a client machine, networked printers, a printer server machine, and a networked printer automatic switching unit. When the client machine issues or instructs a print request in the network via the printer server machine, the networked printer automatic switching unit may switch one printer to another printer suitable for such print request.

Specifically, when the networked printer automatic switching unit receives the print request from the client machine, which designates a given networked printer, the networked printer automatic switching unit checks whether the designated networked printer is in ready-to-print condition. If the designated networked printer is in the ready-to-print condition, the networked printer automatic switching unit checks print-waiting time of the designated networked printer. If it is determined that the designated networked printer is suitable for printing operation, the print data is transmitted to the designated networked printer. If it is determined that the designated networked printer is not suitable for printing operation, the networked printer automatic switching unit checks other networked printers that can be used by the client machine, and determines a suitable printer for printing operation from the other networked printers, and then the print data is transmitted to such networked printer.

In JP-2001-142663-A, networked printer suitability is determined based on certain specific criteria such as print-ready condition of printer or length of waiting time. In such a system, suitable printing resource allocation among printers may not be implemented. In some cases, print requests having large volume of print data may be transmitted to one particular printer. If print requests having print data composed of higher image-area ratio are transmitted to one particular printer, that printer may be operated beyond a normal operating condition, placing too heavy a load on the printer.

JP-2004-272011-A discusses a printer system having a plurality of image forming apparatuses (e.g., printers) and a host machine connected with each other via a network, in which the host machine can monitor fusing temperature set for each of the image forming apparatuses to reduce power consumption required for warming-up the apparatuses. Specifically, when a print command is issued or instructed, the host machine searches and selects an image forming apparatus, which can be activated from energy-save mode with a shortest warming-up time based on fusing temperature data of image forming apparatuses. Then, print data is transmitted to the selected image forming apparatus. In JP-2004-272011-A, when a print command is issued or instructed, a suitable printer can be selected based on condition of printers such as length of warming-up time. However, networked printer suitability may be determined based only on the current condition of the printers such as a warming-up time of printer, and not on past performance. Accordingly, as with JP-2001-142663-A, suitable printing resource allocation among printers may not be fully implemented.

JP-2005-085175-A discusses a printer system to select one of several printers while enhancing printing operation efficiency, in which fusing temperature of printers is monitored so that a waiting time to ready-to-print condition of printers can be reported to a client machine. However, in JP-2005-085175-A, a suitable printer can be selected based only on the current condition of printers, such as a waiting time to set a print-enable condition. Accordingly, as with JP-2001-142663-A and JP-2004-272011-A, suitable printing resource allocation among printers may not be fully implemented.

As such, conventional network systems may use bi-directional communications to obtain printer information. In such systems, user-convenience may be generally prioritized over printer condition. For example, a printer that can be activated sooner may be selected in view of user-convenience or client machine convenience. As a consequence, however, conventional systems may not manage load distribution of print data among networked printers.

If printing load among networked printers is not considered, one specific printer may receive too many print requests that include higher image area data, by which the specific printer may be operated beyond normal operating conditions, wherein the normal operating conditions may be designed for each of printers by setting a given standard value for preferable performance level of image-area ratio for each of printers, for example. Printing operation beyond the range of normal operating conditions may have undesirable effects on the printers. For example, when a printer is operated under too heavy a printing load, image deterioration due to stagnated toner may occur, downtime due to malfunction of devices may occur, and lifetime of parts of printer may be shortened.

### SUMMARY

In one aspect of the invention, a networked printer system is devised. The networked printer system includes one or more client machines disposed on a network, a plurality of networked printers disposed on the network and connected to the one or more client machine via the network, and an automatic switching unit disposed on the network. The automatic switching unit includes a print request receiving unit receiving a print request issued by the client machine, and a printer information acquisition unit obtaining and storing print history information of each one of the networked printers. The automatic switching unit determines one suitable printer from among the plurality of networked printers based on print data of the print request and the print history information of the networked printers, and transmits the print data issued by the client machine, to the one suitable printer.

In another aspect of the invention, a method of selecting a printer in a networked printer system is devised. The networked printer system includes one or more client machines, a plurality of networked printers being connected to the one or more client machine via a network, and an automatic switching unit including a print request receiving unit and a printer information acquisition unit disposed on the network. The method includes the followings steps: a) receiving a print request issued by the client machine by the print request receiving unit; b) obtaining and storing print history information of each one of the networked printers by the printer information acquisition unit; c) determining one suitable printer from among the networked printers by the automatic switching unit based on print data of the print request and the print history information of the networked printers; and d) transmitting the print data of the print request issued by the client machine to the one suitable printer.

In another aspect of the invention, an automatic switching unit, disposed on a networked printer system including a client machine and a plurality of networked printers being connected to the client machine via a network, is devised. The automatic switching unit includes a print request receiving unit receiving a print request issued by the client machine, and a printer information acquisition unit obtaining and storing print history information of each one of the networked printers. The automatic switching unit determines one suitable printer from among the plurality of networked printers based on print data of the print request and the print history information of the networked printers, and transmits the print data issued by the client machine, to the one suitable printer.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 illustrates a networked printer system employing a networked printer automatic switching method according to a first example embodiment;

FIG. 2 illustrates a block diagram of a printer server, useable as an automatic switching unit according to a first example embodiment;

FIG. 3 illustrates a functional block diagram of the automatic switching unit of FIG. 2;

FIG. 4 illustrates a flowchart showing a method of print request processing steps according to a first example embodiment;

FIG. 5 illustrates an example computation scheme of printing-operation priority level indicator based on an actual average image-area ratio and a standard average image-area ratio of printer, and an image-area ratio included in a print request;

FIG. 6 illustrates a flowchart showing a method of network environment check when a printer is added to a network;

FIG. 7 illustrates a flowchart showing a method of print request processing steps according to a second example embodiment;

FIG. 8 illustrates a flowchart showing a method of print request processing steps according to a third example embodiment;

FIG. 9A illustrates a networked printers system employing a networked printer automatic switching method according to a fourth example embodiment; and

FIG. 9B illustrates a block diagram of an automatic switching unit of FIG. 9A.

The accompanying drawings are intended to depict exemplary embodiments of the present invention and should not be interpreted to limit the scope thereof. The accompanying drawings are not to be considered as drawn to scale unless explicitly noted, and identical or similar reference numerals designate identical or similar components throughout the several views.

### DETAILED DESCRIPTION OF EXEMPLARY EMBODIMENTS

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another element, component, region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, Operations, elements, and/or components, but do not preclude the presence or addition of one or more other features, integers, steps, Operations, elements, components, and/or groups thereof.

Furthermore, although in describing views shown in the drawings, specific terminology is employed for the sake of clarity, the present disclosure is not limited to the specific terminology so selected and it is to be understood that each specific element includes all technical equivalents that operate in a similar manner.

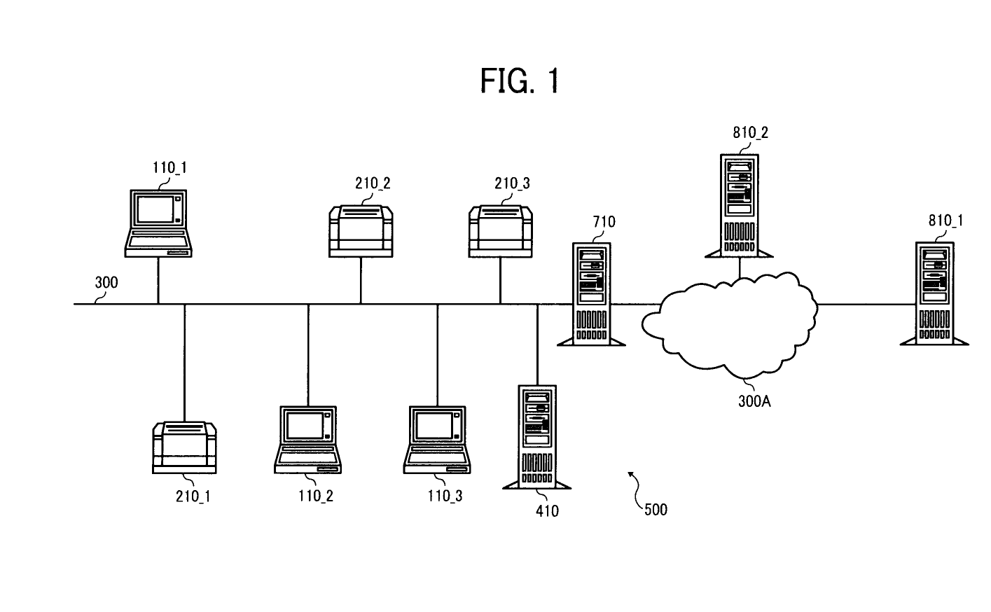

Referring now to the drawings, exemplary network system according to example embodiments are described. FIGS. 1 to 7 illustrate one example of network printer system according to a first example embodiment.

FIG. 1 illustrates an example configuration of network system 500 such as for example networked printer system according to a first example embodiment, in which an automatic switching method can be employed for networked printers connected in the network system 500. The network system 500 may include a plurality of client machines 110 such as client machines 110_1 and 110_2, a plurality of networked printers 210 such as networked printers 210_1 and 210_2, and a printer server machine 410, which may be connected with each other using a network 300 such as for example local area network (LAN), but not limited thereto. Hereinafter, the plurality of client machines 110 may be simply referred to as client machine 110, and the client machine 110_1 and the client machine 110_2 may be used if required. Similarly, the plurality of networked printers 210 may be simply referred to as networked printer 210 or printer 210. The printer server machine 410 may include a networked printer automatic switching unit 400 (hereinafter, the automatic switching unit 400). Further, the client machine 110 can communicate with an information server 810_{—}n disposed outside of the network system 500 using a proxy server 710 and the Internet 300A.

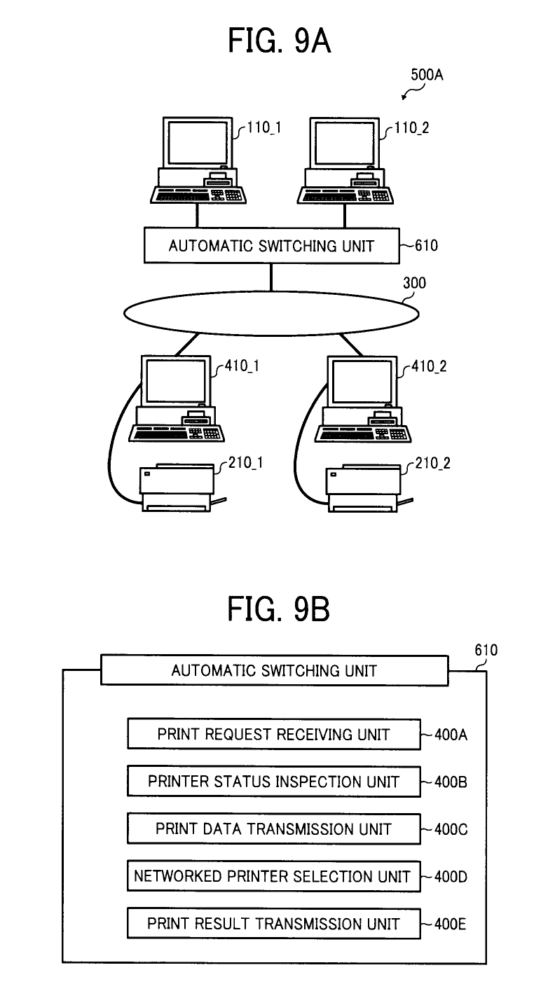

FIG. 1 illustrates one example configuration of network system 500, which includes three client machines 110 and three printers 210, and the printer server machine 410, connected with each other using the network 300. The number of machines included in the network system 500 can be set any number. Further, to be described later with reference to FIG. 9, another configuration pattern can be employed for network system employing an automatic switching function.

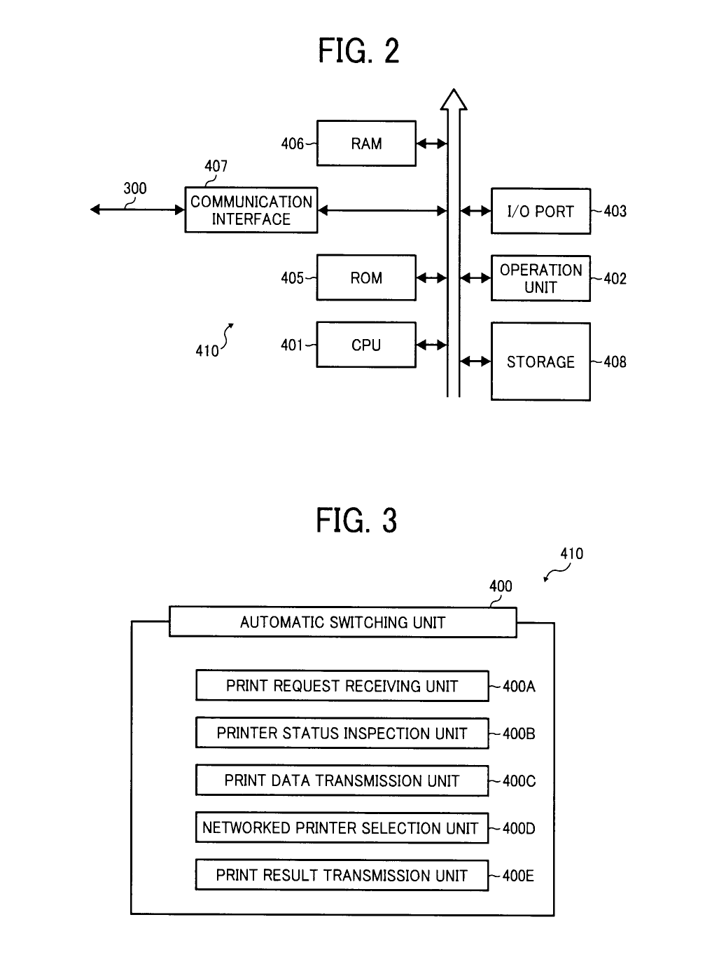

A description is now given to a networked printer system according to a first example embodiment with reference to FIGS. 1 to 3. The networked printer system may be configured as shown in FIG. 1. FIG. 2 illustrates a block diagram of printer server machine 410, installed with the automatic switching unit 400. FIG. 3 illustrates functional blocks of the networked printer automatic switching unit 400 shown in FIG. 1. Such functional block may be implemented by running a software program on the hardware configuration shown in FIG. 2.

The printer server machine 410 may be configured as illustrated in FIG. 2. The printer server machine 410 may be a typical computer, which includes a control unit, a storage 408, and an input/output port 403 (I/O port 403), which are connected with each other using an address bus, a data bus, or the like. The control unit includes a central processing unit 401 (CPU 401), and a memory unit such as a random access memory 406 (RAM 406) and read-only memory 405 (ROM 405). The CPU 401 may use the RAM 406 as a working memory to conduct given processing. The ROM 405 may store control programs such as activation program. Some area in the RAM 406 can be used as backup RAM, in which data can be retained when a power-supply is turned to OFF.

The storage 408 may be a storage device such as hard disk drive (HDD), for example. The storage 408 may store an operating system of the printer server machine 410, software programs for implementing basic application function, setting data (such as data table) or other data to be described later. The storage 408 is connected to a storage controller to control output and input of data to the storage 408. Such storage controller may be connected to the CPU 401 via a bus. Further, the CPU 401 is connected to a communication interface 407 (communication I/F 407), which is used to connect the printer server machine 410 to a network such as LAN, public telephone line, the Internet or the like. The communication I/F 407 is used as a communication unit to transmit and receive data or information.

The printer server machine 410 in FIG. 1 can function as the automatic switching unit 400 (networked printer automatic switching unit 400) when the CPU 401 implements a given function by activating an operating system, in which the CPU 401 implements a given process module. Specifically, as shown in FIG. 3, the automatic switching unit 400 may be configured with a print request receiving unit 400A, a printer status inspection unit 400B, a print data transmission unit 400C, a networked printer selection unit 400D, and a print result transmission unit 400E. Further, printer drivers may be integrated in the operating system.

In FIG. 3, the print request receiving unit 400A receives a print request issued by the client machine 110. The printer status inspection unit 400B is used to obtain history information of print operation (hereinafter, referred to as “print history information”) of each of the printers 210 to select a suitable printer from the printers 210. As such, the printer status inspection unit 400B may also function as a printer information acquisition unit. Based on such print history information, a suitable printer to execute a print request can be selected. For example, such print history information may include information of image-area ratio of printer taken per predetermined unit of time of latest days. The printer status inspection unit 400B may obtain such print history information periodically. For example, the printer status inspection unit 400B may conduct such print history information obtaining process with a given interval. The image-area ratio may mean an area ratio of image (e.g., text, photo) printed or to be printed with respect to a total area of one sheet used for one image.

Further, the printer status inspection unit 400B monitors whether a new printer is added to the network 300. When the new printer is added to the network 300, the printer status inspection unit 400B can obtain information set in the added printer such as a standard average image-area ratio set for the added printer, for example.

With such a configuration, when a printer is connected to a network, the automatic switching unit 400 can automatically obtain a standard image-area ratio of the newly connected printer, by which a network administrator or the like may not need to input information of image-area ratio of printer to the automatic switching unit 400.

Further, when the print request receiving unit 400A receives a print request, the printer status inspection unit 400B inspects whether a printer designated by the client machine 110 or a printer selected by the automatic switching unit 400 is in ready-to-print condition. When the printer is in ready-to-print condition, such printer can be used for printing operation. Further, it can be configured that the printer status inspection unit 400B monitors and inspects all networked printers whether each of them are in ready-to-print condition at a given timing. Then, when the print request receiving unit 400A receives a print request, such information monitored by the printer status inspection unit 400B can be used for switching printers.

The networked printer selection unit 400D may evaluate print history information of each of the printers, and determine (or select) which printer is a suitable printer for a currently requested print request. Specifically, the networked printer selection unit 400D may determine (or select) which printer is a suitable printer based on “image-area ratio” set for each of printers. In this specification, “image-area ratio” is an area ratio of print image on an entire area of one sheet, wherein the image may be formed by toner, ink, or the like. Such “image-area ratio” may mean an “average image-area ratio,” which is an average image-area ratio computed from a plurality of image-printed pages. Further, each of printers may have a designed average image-area ratio, which may be referred to as “standard (or reference) average image-area ratio.” Further, in a second example embodiment to be described later, each of printers may have a recommended print page limit to be printed per predetermined unit of time, which may be referred to as “recommended print page limit.” Further, the networked printer selection unit 400D may determine (select) which printer is a suitable printer by further including a factor of waiting time required to start and implement a printing operation by printer.

The print data transmission unit 400C transmits the print data coming from the client machine 110 to the networked printer 210 under a given condition determined by the printer status inspection unit 400B and the networked printer selection unit 400D. Specifically, the printer status inspection unit 400B may determine that one networked printer 210 selected by the networked printer selection unit 400D or one networked printer 210 designated by the client machine 110 is in ready-to-print condition. Such networked printer 210 can conduct printing of print data transmitted from the client machine 110 using a data format style set for the print data. The networked printer selection unit 400D may determine that one of the networked printer 210 is suitable for printing operation based on information of average image-area ratio of the networked printer 210, for example. The print result transmission unit 400E obtains a print result from the networked printer 210, and transmits the print result to the client machine 110. Further, if the networked printer 210 is not in ready-to-print condition, the print result transmission unit 400E transmits a notice to the client machine 110 that a printing operation could not be conducted.

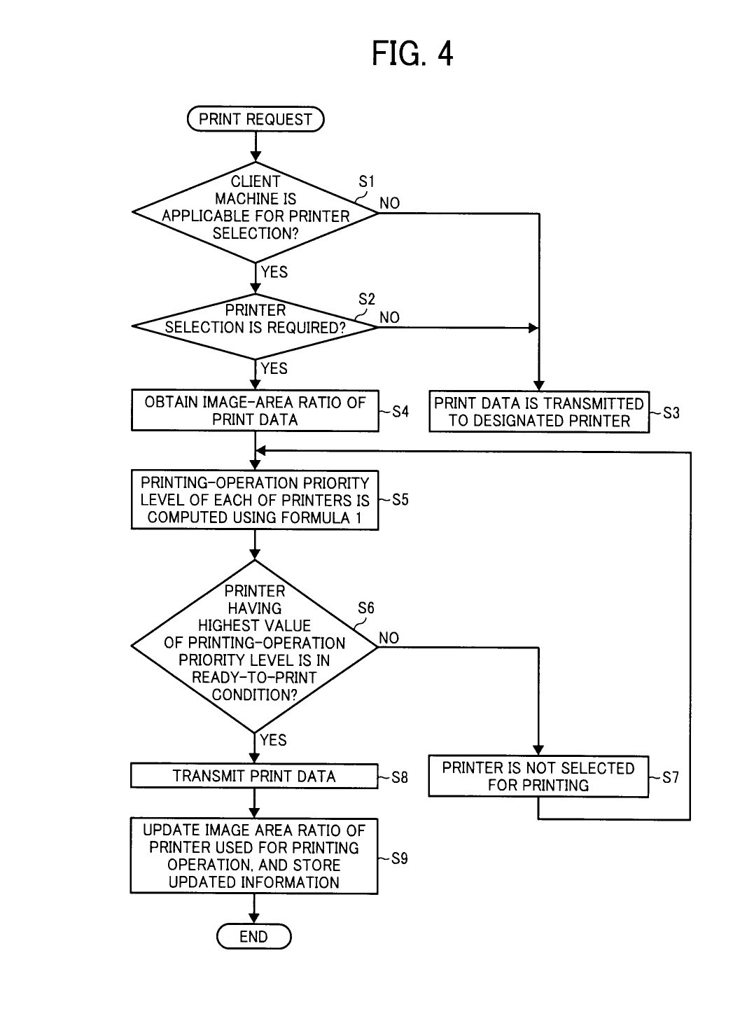

A description is now given to a print request processing steps, which selects a suitable printer from the networked printers 210, according to a first example embodiment with reference to FIG. 4. FIG. 4 illustrates a flowchart showing a method of print request processing steps, which selects a suitable printer from the networked printers 210.

For example, when the client machine 110 connected to the network 300 issues a print request to the networked printer 210_1 connected to the network 300, the automatic switching unit 400 obtains print history information from each of the networked printers 210_{—}n (n is integer such as 1, 2, 3) being in ready-to-print condition. Based on this print history information, the automatic switching unit 400 can determine a suitable printer that the print data is to be transmitted among the networked printers 210_{—}n.

In FIG. 4, when the print request receiving unit 400A of the automatic switching unit 400 receives the print request, the print request receiving unit 400A checks which one of the networked printer 210_{—}n is designated as a destination printer by the print request. Specifically, the print request coming from the client machine 110 may include information of a destination printer, which is one of the networked printers 210_{—}n.

At first, it is determined whether a client machine (i.e., one of client machines 110), which issues a print request, is applicable for “printer selection” (step S1). The printer selection may include a meaning of switching of printer in some cases. The networked printer system can set any one of the client machines 110 as not-applicable for printer selection by the automatic switching unit 400. For example, when a client machine has a given specification and condition, the client machine is determined as applicable for printer selection by the automatic switching unit 400, and when a client machine has another given specification and condition, the client machine is determined as not applicable for printer selection by the automatic switching unit 400 (step S1).

At steps S1 and S2, the print request receiving unit 400A of the automatic switching unit 400 checks whether the printer selection is applicable for the client machine which issues the print request. If it is determined that the client machine 110 is not applicable for printer selection by the automatic switching unit 400, the print data coming from the client machine 110 is transmitted to one of printers 210 designated by the client machine 110 (step S3). If it is determined that the client machine 110 is applicable for printer selection by the automatic switching unit 400, it is determined whether a printer selection is required for the print data (step S2). If it is determined that the printer selection is not required (step S2: No), the print data is transmitted to the printer 210 designated by the client machine 110, or any printer 210 selected by the automatic switching unit 400 (step S3).

Applicable or not-applicable of printer selection can be set or registered in the automatic switching unit 400. It can be set for each one of the client machines 110 whether one client machine 110 is registered for applicable of printer selection and another client machine 110 is registered for not-applicable of printer selection. Based on specification and condition of each of the client machines 110, an automatic switching function can be selectively applied by the automatic switching unit 400 (step S1).

On the other hand, the client machine 110 can issue a print request including an option that the automatic switching function of automatic switching unit 400 is not applicable for the client machine 110 (e.g., canceling of switching function). The automatic switching unit 400 analyzes the print request coming from the client machine 110, and transmits the print data to the printer 210 designated by the client machine 110, or any printer 210 selected by the automatic switching unit 400 (step S3).

If it is determined that printer selection is required for the print data (step S1:Yes and step S2:Yes), the process goes to step S4 and subsequent steps to conduct printer selection. At step S4, the networked printer selection unit 400D obtains image-area ratio of the print data.

The automatic switching unit 400 may determine one printer, to which the print data is to be transmitted, based on consideration of image-area ratio of the print data included in a currently requested print request and print history information of each of printers. In such process, a printer with the greatest positive gap between the actual image-area ratio and the standard image-area ratio is selected as the suitable printer, to which the print data is to be transmitted among the printers. In other words, a printer that can reduce a gap between an actual value of print history information and a standard value of printer with a greatest level is selected as the printer that the print data is to be transmitted among the printers.

Specifically, the networked printer selection unit 400D sets printing-operation priority level for each of printers, and determines a suitable printer that is desirably selected for a currently requested print request so that the suitable printer can be selected for conducting a printing operation under a suitable condition. The printing-operation priority level for each of printers can be computed using following formula 1 and parameters of 1) an image-area ratio of print data included in print request, 2) print history information of each of printers, wherein the print history information may be an actual average image-area ratio each of printers (or image forming units); and 3) a standard average image-area ratio of each of printers (or image forming units).

Specifically, the printing-operation priority level of printers can be computed (step S5) using following formula 1 as printing-operation priority level indicator P1.

P1=(B1−A1)/(C1−A1) (formula 1)

in which, an actual average image-area ratio of printer (A1), a standard average image-area ratio of printer (B1), and an image-area ratio included in print request (C1) issued by the client machine 110 are input.

The printing-operation priority level indicator P1 indicates how print data corresponding to the print request issued by the client machine 110 can contribute to reduce a difference between the actual average image-area ratio (A1) and the standard average image-area ratio (B1) of each of printers 210. The networked printer selection unit 400D determines that the greater the printing-operation priority level indicator P1, the greater the printing-operation priority level of the printer 210.

At step S6, it is determined whether a printer having the highest value of the printing-operation priority level is in ready-to-print condition. If it is determined that the printer having the highest value of the printing-operation priority level is not in the ready-to-print condition due to some reasons such as shutdown of main power source, or sheet jamming correction process, this printer having the highest value is not selected for printing (step S7). Then, other printers are sequentially searched in the order of higher to lower printing-operation priority level, and a printer having a higher printing-operation priority level may be determined or selected at last.

The print data transmission unit 400C of the automatic switching unit 400 transmits the print data to one of the printers 210, selected at step S6, having a highest or higher value for the printing-operation priority level indicator P1 (step S8), and updates an actual average image-area ratio of the printer that has printed the print data, and stores updated information of actual average image-area ratio of the printer (step S9).

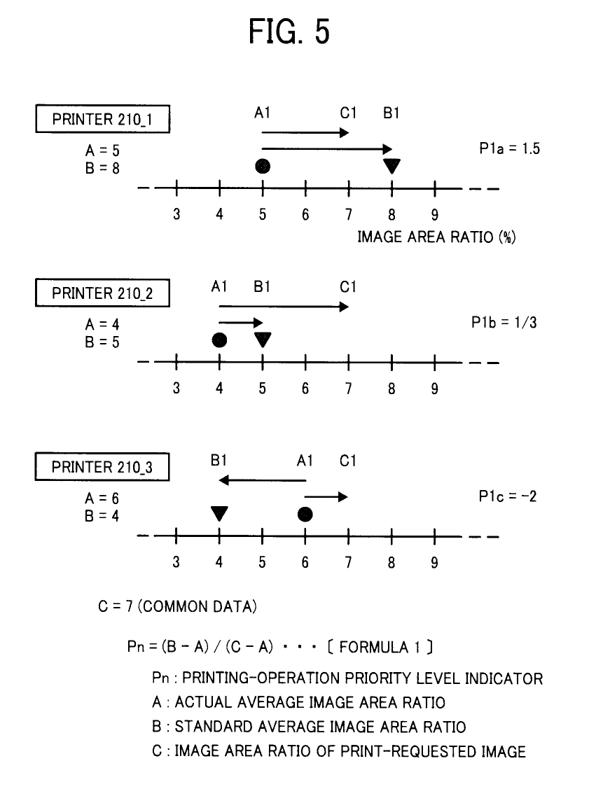

FIG. 5 illustrates an example computation process of printing-operation priority level. FIG. 5 shown one example case, in which three printers 210_1, 210_2, 210_3 are connected to the network 300 via the printer server machine 410, and each of printers has an actual average image-area ratio (A1) and a standard average image-area ratio (B1). A print request includes a print data (or image data) having an image-area ratio (C1) used as common data for this example.

As for the printer 210_1, the image-area ratio (Cl) of print request exists between the actual average image-area ratio (A1) and standard average image-area ratio (B1). As for the printer 2102, the image-area ratio (C1) of print request exists outside the actual average image-area ratio (A1) and standard average image-area ratio (B1) while relatively close to the standard average image-area ratio (B1). In such a case, compared to the printer 210_2, the printer 210_1 has a greater effect of reducing a gap between the actual average image-area ratio (A1) and the standard average image-area ratio (B1). In other words, the printer 201_1 having the greatest positive gap between the actual image-area ratio and the standard image-area ratio is selected as one suitable printer, to which the print data is to be transmitted.

Further, as for the printer 2103, the image-area ratio (C1) of print request exists outside the actual average image-area ratio (A1) and standard average image-area ratio (B1), and close to the actual average image-area ratio (A1). In such a case, the printer 210_3 has a greater effect of increasing a gap between the actual average image-area ratio (A1) and standard average image-area ratio (B1).

In an example shown in FIG. 5, an image-area ratio (C1) of the print request issued by the client machine 110 is set to 7%, and then the printing-operation priority level indicator P1 is computed as P1a=1.5, P1b=⅓, P1c=−2 for the printers 210_1, 210_2, and 210_3, respectively, for example. The automatic switching unit 400 transmits the print data to the printer 210_1 having the highest printing-operation priority level indicator P1 and implements printing operation by the printer 210_1. It should be noted that when an image-area ratio (C1) of print request is changed, the printing-operation priority level indicator P1 of each of the printers 210 also changes, and thereby a destination printer to be transmitted with the print data may change. Further, the printing-operation priority level can be computed using other method.

Further, some printers connected to the network may be color printers, which have a plurality of image forming units (e.g., three units) corresponding to each of primary colors such as cyan, magenta, and yellow, for example. As for such color printer, an average image-area ratio of each of primary colors can be obtained. Based on such average image-area ratio of primary colors, an average image-area ratio of one color printer is computed, and then transmitted to the automatic switching unit 400, and such computed average value is assumed as an actual average image-area ratio for the color printer, and then the printing-operation priority level is determined (step S5 in FIG. 4).

In such a case of using a plurality of image forming units, the printing-operation priority level indicator P may be determined by using an actual average image-area ratio, computed by averaging image-area ratio obtained for all of primary colors. Further, the printing-operation priority level indicator P may be determined using other computation. For example, different weight factor may be applied for each of primary colors to compute an actual average image-area ratio of one color printer. Further, an actual average image-area ratio of each of primary colors (i.e., an actual average image-area ratio of each of image forming units) can be transmitted from a color printer to the automatic switching unit 400, and the automatic switching unit 400 may compute an actual average image-area ratio of one color printer based on such obtained information of each of primary colors as similar to the previous case. Such computed actual average value of image forming units may be registered as a printer specific information and used to determine the printing-operation priority level of printers.

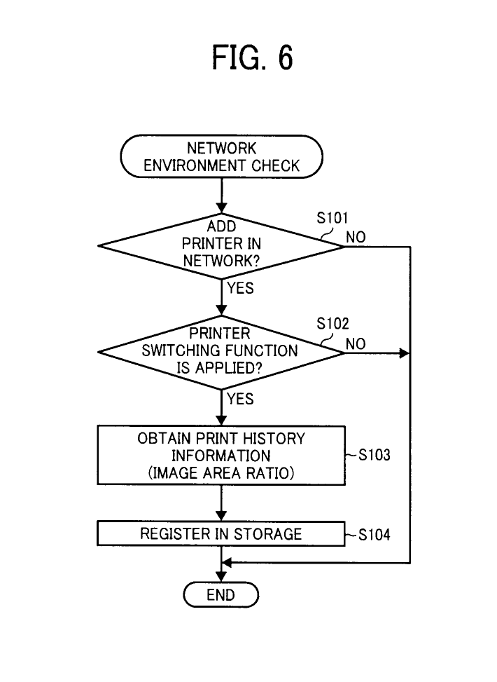

In example embodiments disclosed in this specification, one or more new printers 210 can be connected to the network 300 and registered to the networked printer system, wherein such registration can be conducted by the automatic switching unit 400 as a normal process, which may be conducted while conducting other process. FIG. 6 illustrates a flowchart showing an example method of such printer registration process to a network system, which may be conducted while checking a network environment.

In FIG. 6, the printer status inspection unit 400B of the automatic switching unit 400 monitors the network 300 whether a new printer is added to the network 300 (step S101). If a new printer is added (step S101:Yes), it is checked whether a printer switching function is applied to the added new printer (step S102). If the printer switching function is applied (step S102:Yes), print history information including an actual average image-area ratio and a standard average image-area ratio registered in the added new printer of the added new printer are obtained (step S103), and registered in a storage (step S104). The standard average image-area ratio may be defined as an allowable range of image-area ratio. Such information may be used to select one of the printers 210 that print data is to be transmitted when a print request is issued at a later time.

As above-described, in a first example embodiment, the automatic switching unit 400 may obtain an actual average image-area ratio as print history information of each of printers, wherein the actual average image-area ratio may affect printing performance level of image forming unit(s) of printers.

When a client machine issues a print request, a printing-operation priority level is computed based on information of actual average image-area ratio of printer. Specifically, printers are sequentially searched in view of higher printing-operation priority level and ready-to-print condition to select a suitable printer, in which a printer with the greatest positive gap between the actual image-area ratio, stored as print history information in printer, and the standard image-area ratio is selected as the suitable printer, to which the print data is to be transmitted among the printers. In other words, a printer that can reduce a gap between an actual value of print history information and a standard value of printer with a greatest level is selected as the printer that the print data is to be transmitted among the printers. With such a configuration, each of printers connected to the network 300 can be used at preferable operating conditions without blocking print requests issued by the client machines and without degrading user convenience.

In a first example embodiment, a switching function can be set applicable or not-applicable for each of client machines (step S1 in FIG. 4). For example, depending on use-environment of each of client machines, the switching function may be canceled for any one of client machines. With such a configuration, a network system adapted to client machine environment or network environment can be configured with various ways.

Further, a client machine may include an application selection unit that can temporarily cancel a switching function conductable by the automatic switching unit 400 so that a switching function can be set applicable when each of client machines requires such switching function (step S1 in FIG. 4). With such a configuration, a network system that can enhance user convenience can be implemented. For example, a client machine which issues print requests of classified documents frequently may be set as not-applicable of switching function, in which classified documents may be always output by a same one printer designated by the client machine to enhance print data security. In the above described network system 500, a plurality of printers such as a color printer employing image forming units may be connected to the network 300. At step S2, the number of printers, for which an actual average image-area ratio is out of allowable range of average image-area ratio, exceeding a given proportion of a total number of printers may be used as one judgment criterion. The automatic switching unit 400 may be activated when the numbers of printers being operated at out of allowable range of image-area ratio becomes a given number or more. Specifically, if the number of printers, for which an actual average image-area ratio is out of allowable range of average image-area ratio, exceeds a given proportion of a total number of printers, the automatic switching unit 400 may be activated to select a printer from among printers. If the number of printers, for which an actual average image-area ratio is out of allowable range, is less than the given proportion, print data is output to a printer designated by the client machine 110, or any printer selected by the automatic switching unit 400. With such a configuration, each of printers connected to the network 300 can be used at preferable operating conditions while enhancing user convenience such as the user can select a printer.

In such configured system, the standard image-area ratio of one printer may be set as a standard image-area ratio range, wherein the standard image-area ratio range may be referred to an allowable range of average image-area ratio of printer, hereinafter. For example, an allowable range of average image-area ratio of one printer 210 may be set from 3% to 7%. If an actual average image-area ratio of print data is 8%, such one printer 210 is determined out of the allowable range, and then other printers are similarly checked (step S2). As such, a given allowable range of average image-area ratio may be set for each of printers, and such allowable range of average image-area ratio may be compared with an actual average image-area ratio of each of printers. By conducting such comparison, the number of printers, for which the actual average image-area ratio is out of the allowable range of average image-area ratio, can be identified.

For example, if the number of printers being out of the allowable range exceeds 50% of total number of printers disposed on the network, the automatic switching unit 400 may be activated, and a step of obtaining image-area ratio of the print data (step S4) and subsequent steps are conducted. If the number of printers being out of the allowable range is less than 50% of total number of printers disposed on the network, print data is transmitted to a printer designated by the client machine 110, or any printer selected by the automatic selection unit 410, by which the process ends (step S3).

As such, if the number of printers, for which an actual average image-area ratio is out of allowable range of average image-area ratio, exceeds a given proportion of a total number of printers, the automatic switching unit 400 may be activated to select a printer from among printers. If the number of printers, for which an actual average image-area ratio is out of allowable range, is less than the given number, print data is output to a printer designated by the client machine 110, or any printer selected by the automatic switching unit 400. With such a configuration, each of printers connected to the network 300 can be used at preferable operating conditions while enhancing user convenience such as the user can select a printer. Such allowable range of average image-area ratio of printers and a proportion of printers becoming out of allowable range of average image-area ratio can be set to any values other than the above-described values.

In the above described example embodiment, print history information of each of networked printers may be obtained by the automatic switching unit 400 as a normal process at a given timing, which can be conducted while conducting other process. Further, print history information of each of networked printers may be obtained by the automatic switching unit 400 when the print request is received. For example, when the print request is received, the print history information may be obtained while checking whether each of printers is in ready-to-print condition. In such configuration, the above-described preferable effect can be similarly attained for the network system.

A description is now given to a networked printer system according to a second example embodiment, in which print history information may be the number of printed pages per predetermined unit of time by a printer. In a second example embodiment, a printer is set with a recommended print page limit of printer per predetermined unit of time, and an actual number of printed pages of printer per predetermined unit of time is used as print history information of printer. The recommended print page limit is the number of preferably printable pages, in which a printer may be operable at a desirable condition. The actual number of printed pages is the number of pages actually printed by a printer. Such recommended print page limit and actual number of printed pages of printer, and page numbers included in print data of print request issued by a client machine may be used to select a suitable printer from among printers. The overall configuration of networked printer system of a second example embodiment is same as a first example embodiment (see FIG. 1), by which an explanation of configuration of networked printer system is omitted. The configuration of automatic switching unit 400 disposed in a print server is same as the configuration illustrated in FIG. 3 (functional block diagram) such as the automatic switching unit 400 includes the print request receiving unit 400A, the printer status inspection unit 400B, the print data transmission unit 400C, the networked printer selection unit 400D, and the print result transmission unit 400E. In a second example embodiment, print history information of printer may be an actual number of printed pages per predetermined unit of time, wherein such actual number of printed pages affect a printing performance level of image forming units of printers. Each of printers can be operated under a suitable condition using the actual number of printed pages as print history information.

In a second example embodiment, the printer status inspection unit 400B is used to obtain most recent history information of print operation (or print history information) of each of the networked printers to select a suitable printer from the printers 210. Based on such most recent print history information and “the recommended print page limit” set for printers, a suitable printer to execute a print request can be selected. For example, such print history information may include the actual number of printed pages per predetermined unit of time by a printer. Then, the networked printer selection unit 400D evaluates page numbers included in a print request issued by a client machine and actual number of printed pages by each of printers, which is stored as print history information, and determines which printer is in ready-to-print condition and suitable to execute a currently requested print request.

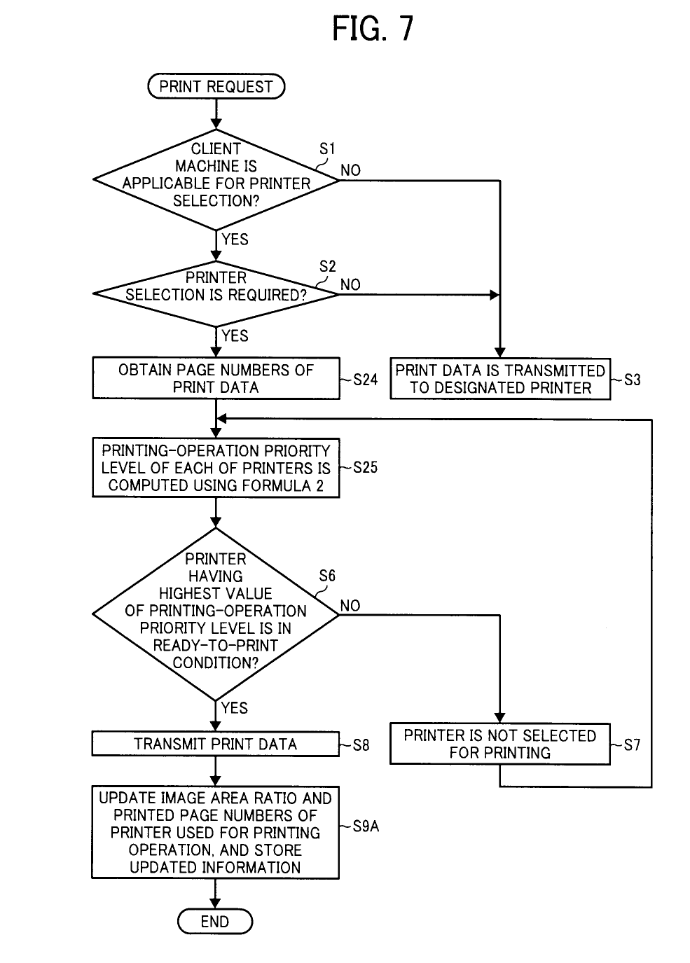

A description is now given to a print request processing steps according to a second example embodiment, which selects a suitable networked printer 210 with reference to FIG. 7, which illustrates a process of selecting a suitable printer from the networked printer 210. The process shown in FIG. 7 includes similar steps shown in FIG. 4 according to a first example embodiment. Hereinafter, steps specifically set for the second example embodiment are mainly explained. When the client machine 110 connected to the network 300 issues a print request, which may designate the networked printer 210_1 connected to the network 300, the automatic switching unit 400 may obtain print history information from each of the networked printers 210_{—}n, being in ready-to-print condition. The automatic switching unit 400 may obtain an actual number of printed pages per predetermined unit of time by each of printers 210 as print history information. Based on such information, the automatic switching unit 400 may determine a suitable printer that the print data is to be transmitted among the networked printers 210_{—}n.

In a second example embodiment, steps S1 to step S3 in FIG. 7 are same as steps S1 to S3 in a first example embodiment (see FIG. 4), and it is determined whether “printer selection (or printer switching)” is applicable or not-applicable for a client machine which issues the print request. If the printer switching (or selection) process is not required (step S2:No), the print data is transmitted to the printer 210 designated by the client machine 110, or any printer 210 selected by the automatic switching unit 400 (step S3).

If it is determined that the printer switching (or selection) process is required for the concerned print data (step S2:Yes), the process goes to step S24 and subsequent steps to select a printer. At step S24, the printer status inspection unit 400B of the automatic switching unit 400 may obtain or collect print history information from each one of printers via the network 300. In a second example embodiment, the print history information includes an actual number of printed pages per predetermined unit of time by each of printers. The predetermined unit of time may be most-recent given time period, which may be defined as any time period in view of environment of the network system.

Then, the networked printer selection unit 400D determines the printing-operation priority level based on the print history information of each one of printers, in which the printing-operation priority level of each one of the printers at the current timing is computed. Specifically, a printer having higher printing-operation priority level and having ready-to-print condition is sequentially searched from among the printers. A printer with the greatest positive gap between the actual number of printed pages (i.e., print history information) and the recommended print page limit is selected as a printer that the print data is to be transmitted among the printers (step S25).

Specifically, the printing-operation priority level of each of printers is computed (step S25) using following formula 2 as printing-operation priority level indicator P2.

P2=(B2−A2)/(C2−A2) (formula 2)

in which, an actual number of printed pages of printer (A2), a recommended print page limit of printer (B2), and page numbers (C2) included in print request issued by the client machine 110 are input.

The printing-operation priority level indicator P2 indicates how print data (or image data) of the print request issued by the client machine 110 can contribute to reduce a gap between the actual number of printed pages (A2) and the recommended print page limit of each of printers 210. The networked printer selection unit 400D determines that the higher the printing-operation priority level indicator P2, the higher the printing-operation priority level for the printer 210.

Further, some printers connected to the network may be color printers, which have a plurality of image forming units corresponding to each of primary colors such as cyan, magenta, and yellow, for example. As for such color printer, average numbers of page printed by each of primary colors (i.e., image forming units) can be obtained, and then average numbers of page printed by color printer can be computed based on such average numbers of page printed by each of primary colors. Then, the printing-operation priority level can be determined based on the average numbers of page printed by color printer. In such a case, the printing-operation priority level indicator P2 may be determined by using average number of pages printed by of each of primary colors by setting an equal weight factor to each of primary colors. Further, the printing-operation priority level indicator P2 may be determined using other computation. For example, different weight factors may be applied for each one of primary colors to compute an actual number of printed pages by one color printer.

In step S8, the print data transmission unit 400C of the automatic switching unit 400 transmits the print data to one of the printers 210 having a highest value of the printing-operation priority level indicator P2, which is selected at step S6, and then the automatic switching unit 400 updates the actual number of printed pages by one of the printers 210 that has conducted a printing operation of the print data, and then stores updated information of the actual number of printed pages of the printers 210 (step S9A).

As such, in the network 300 connected with a printer such as color printer having a plurality of image forming units, the automatic switching unit 400 may compute a printing-operation priority level of printer based on an actual number of printed pages and a recommended print page limit per predetermined unit of time set for each one of image forming units, for example. With such processing, the printing-operation priority level can be set for printers, and each one of printers can be operated under a suitable condition.

Further, as similar to the process shown in FIG. 6 according to a first example embodiment, when a new printer is connected or added to the network 300, the automatic switching unit 400 may automatically obtain an actual number of printed pages and a recommended print page limit per predetermined unit of time, stored in a memory unit of printer. Such information can be used for switching printers when a print request is issued by a client machine. As such, a user may not be required to conduct manual input operations, which may be complex, and thereby enhancing convenience of user operations.

One modification of network system of a second example embodiment is further explained. At step S2, the recommended print page limit may be set as a “recommended print page limit range,” which may be defined as an allowable range of number of print page per predetermined unit of time such as per month. The automatic switching unit 400 may be activated to select a printer when a proportion of printers, for which an actual number of printed pages is out of the allowable range of number of print page, exceeds a given threshold. Specifically, the automatic switching unit 400 may be activated if the number of printers, for which an actual number of printed pages is out of the allowable range of number of print page, exceeds a given proportion of a total number of printers. If the number of printers, for which an actual number of printed pages is out of the allowable range, is less than a given number, print data is output to a printer designated by the client machine 110, or any printer selected by the automatic switching unit 400. With such a configuration, each of printers connected to the network 300 can be used at preferable operating conditions while enhancing user convenience such as the user can select a printer.

In such configured system, the recommended print page limit range per month of one printer 210 may be set as an allowable range of from 3,000 to 5,000 pages per month, for example. If an actual number of printed pages per month of the printer 210 becomes 5,500 pages, the printer 210 is determined out of the allowable range, and other printers may be checked similarly. For example, if the number of printers becoming out of the allowable range is greater than 50% of total number of printers, the automatic switching unit 400 is activated, and the automatic selection unit 410 obtains page numbers corresponded to the print request data (step S4), and subsequent steps are conducted. If the number of printers becoming out of the allowable range is less than 50% of total number of printers, print data is transmitted to a printer designated by the client machine 110, or any printer selected by the automatic selection unit 410, by which the process ends (step S3). Such allowable range of preferably printable page numbers per predetermined unit of time for each one of printers, and a given proportion of printers becoming out of allowable range can be set to any values other than the above described values.

As such, if the number of printers that have an actual number of printed pages, which is out of the allowable range, becomes a given proportion of a total number of printers, the automatic switching unit 400 may be activated to select a printer. If the number of printers becoming out of the allowable range is less than the given proportion, print data is output to a printer designated by the client machine 110, or any printer selected by the automatic switching unit 400. With such a configuration, each of printers connected to the network 300 can be used at preferable operating conditions while enhancing user convenience such as the user can select a printer. Such allowable range of preferably printable page numbers per predetermined unit of time for each one of printers, and a proportion of printers becoming out of the allowable range can be set to any values other than the above mentioned values.

In the above described second example embodiment, the actual number of printed pages per predetermined unit of time for each one of printers may be obtained as print history information, wherein such print history information may affect a printing performance level of image forming units of printer.

When a client machine issues a print request, a printing-operation priority level may be computed for each one of printers based on the actual number of printed pages and the recommended print page limit (or recommended print page limit range). Based on the computed printing-operation priority level of each one of printers, printers are sequentially searched for a suitable printer having a highest or higher printing-operation priority level and ready-to-print condition. A printer with the greatest positive gap between the actual number of printed pages, stored as print history information, and the recommended print page limit is selected as a suitable printer that the print data is to be transmitted among the printers. With such a configuration, each of printers connected to the network 300 can be used at preferable operating conditions without blocking print requests issued by the client machines and without degrading user convenience.

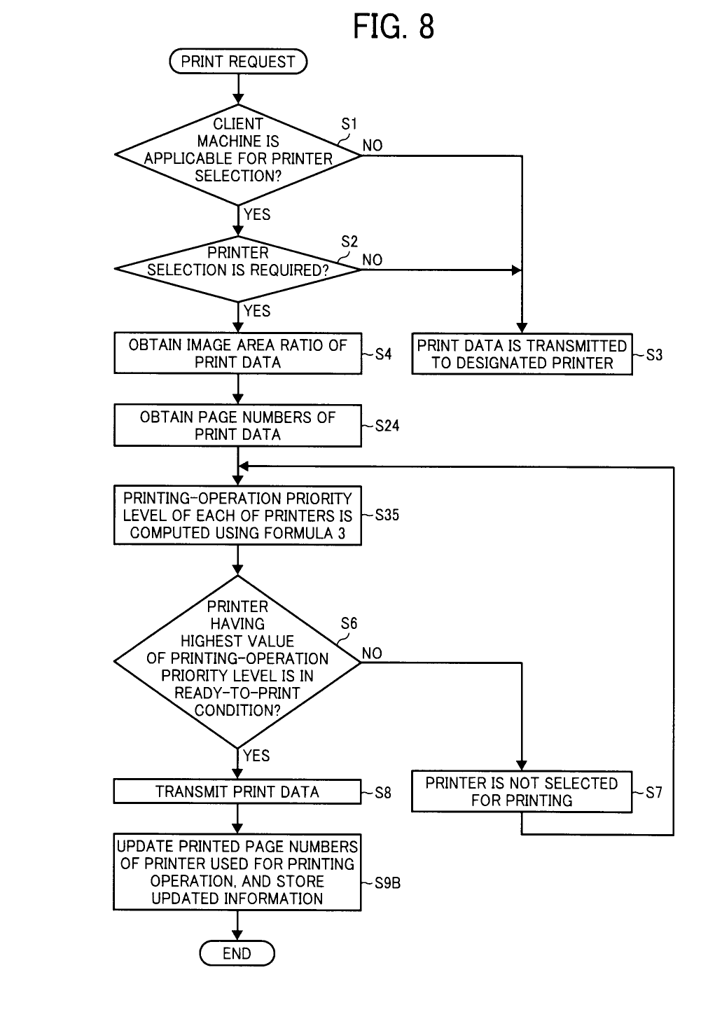

A description is now given to a networked printer system according to a third example embodiment. The overall configuration of networked printer system of third example embodiment is same as a first example embodiment (see FIG. 1), by which an explanation of configuration of networked printer system is omitted. The configuration of automatic switching unit 400 is same as a first example embodiment (see a functional block diagram of FIG. 3), by which an explanation of configuration of automatic switching unit 400 is also omitted. A description is now given to a print request processing step of automatic switching unit 400 with reference to FIG. 8, which illustrates a flowchart showing a method of print request processing steps.

In a third example embodiment, both of actual average image-area ratio and actual number of printed pages per predetermined unit of time are checked as print history information for each one of printers, wherein the actual average image-area ratio and actual number of printed pages may affect a printing performance level of image forming units of printer. Each one of printers can be operated under a suitable condition using information of actual average image-area ratio and actual number of printed pages.

In a third example embodiment, steps S1 to S3 in FIG. 8 are same as steps S1 to S3 in a first example embodiment (see FIG. 4), and it is determined whether switching process is applicable or not-applicable using the print request receiving unit 400A at steps S1 and S2 for a client machine which issues a print request. If the switching process is not required (step S2:No), the print data is transmitted to the printer 210 designated by the client machine 110, or any printer 210 selected by the automatic switching unit 400 (step S3).

If it is determined that the printer switching or selection process is required for the concerned print data (step S1:Yes, S2:Yes), the process goes to step S4 and subsequent steps to select a printer. In such printer switching or selection process, the automatic switching unit 400 refers to both of actual average image-area ratio and actual number of printed pages per predetermined unit of time as print history information. For example, an image-area ratio of print data is obtained when the client machine 110 issues a print request (step S4), and page numbers included in the print data is obtained (step S24). Then, the printing-operation priority level of each one of the printers is computed (step S35) using the obtained data. Specifically, the printing-operation priority level of each of printers can be computed (step S35) using following formula 3 as printing-operation priority level indicator P3 by using the networked printer selection unit 400D.

P3=a[(B1−A1)/(C1−A1)]+b[(B2−A2)/(C2−A2)] (formula 3)

The printer status inspection unit 400B of the automatic switching unit 400 obtains following data for each of printers: an actual average image-area ratio of printer (A1); a standard average image-area ratio of printer (B1); an actual number of printed pages of printer (A2); a recommended print page limit (B2); an image-area ratio (C1) of print data (or image data) of print request currently requested by client machine; and page numbers (C2) of print data (or image data) of print request currently requested by client machine.

In formula 3, “a” and “b” are coefficient of weighting factor of each of average image-area ratio and page numbers for printing, respectively. If the average image-area ratio is set with a higher priority, “a>b” is set; if the page numbers for printing is set with a higher priority, “a<b” is set; and if both of them is set with a same priority, “a=b” is set. Further, the printing-operation priority level can be computed with other methods.

The networked printer selection unit 400D determines that the higher the printing-operation priority level indicator P3, the higher the printing-operation priority level for the printer 210. At step S6, as similar to other previously described embodiments, it is determined whether a printer having the highest value for the printing-operation priority level is in ready-to-print condition. If it is determined that the printer having the highest value for the printing-operation priority level is not in ready-to-print condition due to some reasons such as shutdown of main power source, or sheet jamming correction process, such printer having the highest value is not selected for printing (step S7). Then, other printers are sequentially searched in the order of the higher to lower printing-operation priority level to select one printer having a higher printing-operation priority level at last.

At step S8, the print data transmission unit 400C of the automatic switching unit 400 may transmit the print data to the selected printer 210 having the highest or higher value for the printing-operation priority level indicator P3, and the print result transmission unit 400E may update the actual average image-area ratio of the printer used for the printing operation and the actual numbers of printed pages, and store updated information of average image-area ratio and actual numbers of printed pages of the printer (step S9B). With such a configuration, each of printers connected to the network 300 can be used at preferable operating conditions without blocking print requests issued by the client machines and without degrading user convenience.

A description is now given to a networked printer system according to a fourth example embodiment with reference to FIG. 9, which illustrates a network system 500A. In an example configuration shown in FIG. 9A, an automatic switching unit described in the above example embodiments may be independently disposed in the network system 500A, whereas in the previous explained example embodiments, an automatic switching unit may be included in a networked device or apparatus. The network system 500A shown in FIG. 9A may be configured with a plurality of client machines 110, an automatic selection unit 610 used as networked printer automatic switching unit, the network 300, a plurality of printer server machines 410, and networked printers 210 connected to the printer server machines 410. Each of the printer server machines 410 may include a printer driver matched to the each of the networked printer 210.

The automatic selection unit 610 may be configured as shown in FIG. 9B (block diagram) as similar to the automatic switching unit 400 shown in FIG. 3, and the automatic selection unit 610 may function as similar to the automatic switching unit 400. Each of the printer server machines 410 can communicate with the networked printer 210 to obtain the above described average image-area ratio an/or print page numbers per predetermined unit of time, by which the printer server machine 410 can obtain such information in advance if required. Further, the printer server machine 410 may be assumed as one unit used with a networked printer with respect to the automatic selection unit 610.

In the network system 500A, each of the client machines 110, not connected to the printer 210 directly, may transmit a print request to the automatic selection unit 610. The automatic selection unit 610 may obtain the above described print history information of printers (e.g., average image-area ratio and/or print page numbers per predetermined unit of time), and monitors whether a print operation is enabled via each of the printer server machines 410. Then, the automatic selection unit 610 may conduct a printer selection or switching process as similar to other example embodiments to select a suitable printer connected to the printer server machine 410. Then, the print data is transmitted to the suitable printer via the printer server machine 410. With such a configuration, each of printers connected to the network 300 can be used at preferable operating conditions without blocking print requests issued by the client machines and without degrading user convenience.

Further, instead of providing the automatic selection unit 610 as an independent unit in a network system, a function of automatic switching unit 400 can be provided in any one of the printer server machines 410, for example. With such a configuration, each of printers connected to the network 300 can be used at preferable operating conditions without blocking print requests issued by the client machine(s) and without degrading user convenience.

Further, instead of providing a printer server and/or switching unit as an independent unit in a network system, a function of automatic switching unit 400 may be included in any one of the networked printers connected to the network, for example. If the above described automatic switching function can be included in any one of the networked printers, a networked printer system connecting a plurality of printers can be configured without a print server or the like, by which the networked printer system can be configured with reduced cost.

As above described, each of printers can be used under a suitable condition for printers, by which quality problems of image forming can be prevented, and downtime of printers can be reduced or prevented, by which a network system efficiency can be enhanced. Further, material saving can be achieved by reducing needs of spare or replacement parts. Material saving has been becoming an important matter in view of environmental concern, resource depletion, or the like.

In the above described example embodiments, a client machine may issue a print request to a network including a networked printer automatic switching unit, and upon receiving a print request, the networked printer automatic switching unit selects a suitable printer from the networked printers disposed on the network using bi-directional communications with the networked printers. Specifically, the networked printer automatic switching unit may obtain print history information from each of the networked printers to select a suitable printer from the networked printers based on the print history information, and implements the print request using the suitable printer. With such a configuration, malfunction or shortened lifetime of apparatus caused by toner stagnation, parts degradation, and resultant image quality degradation, which may be observed in conventional systems, can be effectively reduced or prevented. Further, the above described example embodiments configuration can contribute to material saving.

As above described, when a print request is issued, a networked printer with the greatest positive gap between the actual value of print history information (e.g., number of printed pages) and the standard or recommended value of print history information (e.g., recommended print page limit) is selected as a suitable printer by using the automatic switching unit, and the print data is to be transmitted to the suitable printer. With such a configuration, image quality deterioration, malfunction or shortened lifetime of printers can be effectively prevented.

With the above-described configuration, when a printer having the highest printing-operation priority level cannot be used for printing, other printers are sequentially checked to select a printer having a higher printing-operation priority level and ready-to-print condition, and print data (or image data) can be transmitted to such printer, by which printing efficiency of the network system can be enhanced by conducting printing operation with a reduce time in view of printers conditions.

With the above-described configuration, image quality deterioration, malfunction or shortened lifetime of printer can be effectively prevented. Such problems may be caused by stagnated toner, which may be caused by a lower image-area ratio.

With the above-described configuration, when a color printer having a plurality of image forming units is connected to a network, an actual image-area ratio and standard image-area ratio of each of image forming units, corresponding to different colors, may be computed to determine a printing-operation priority level of printer, by which a suitable printer can be selected.

With the above-described configuration, when a given proportion of printers, for which the actual average image-area ratio is out of allowable range of image-area ratio, exceeds a given number, the automatic switching unit 400 may be activated, to select a printer. When a given proportion of printers, for which the actual average image-area ratio is out of allowable range of image-area ratio, is less than the given number, the automatic switching unit 400 may not be activated. As such, the automatic switching unit 400 may be activated when it is determined that the automatic switching unit 400 can be effectively utilized for the network system having networked printers.

With the above-described configuration, when a printer is connected to a network, the automatic switching unit can automatically obtain an standard average image-area ratio of printer, by which a network administrator or the like may not need to input information of standard average image-area ratio of printer to the automatic switching unit.

With the above-described configuration, print history information may include information of page numbers such as actual number of printed pages. Image quality deterioration, malfunction or shortened lifetime of printer can be effectively prevented using information of actual number of printed paged. Such problems may be caused when an actual number of printed pages becomes greater than a recommended print page limit.

With the above-described configuration, when color printer having a plurality of image forming units is connected to a network, an actual number of printed pages and recommended print page limit of each of image forming units, corresponding to different colors, can be used to computed and determine a printing-operation priority level of color printer, by which a suitable printer can be selected.

With the above-described configuration, when a proportion of printers, for which an actual number of printed pages per predetermined unit of time is out of a recommended print page limit, exceeds a given number, the automatic switching unit may be activated to select a printer. When a proportion of printers, for which an actual number of printed pages per predetermined unit of time is out of a recommended print page limit, is less than the given number, the automatic switching unit may not be activated. As such, the automatic switching unit may be activated when it is determined that the automatic switching unit can be effectively utilized for the network system having networked printers.

With the above-described configuration, when a printer is connected to a network, the automatic switching unit can automatically obtain a recommended print page limit of connected printer, by which a network administrator or the like may not need to input information of recommended print page limit of printer to the automatic switching unit.

With the above-described configuration, print history information used for selecting a printer that print data is to be transmitted may include both of an actual average image-area ratio and actual number of printed pages of printer. By using the automatic switching unit 400 and both of actual average image-area ratio and actual number of printed pages of printer, a printer with the first greatest positive gap between the actual image-area ratio and standard image-area ratio, and with the second greatest positive gap between the actual number of printed pages and the recommended print page limit is selected as a suitable printer, to which the print data is to be transmitted among the printers.

With the above-described configuration, when a printer is connected to a network, the automatic switching unit can automatically obtain a standard average image-area ratio and a recommended print page limit of printer, by which a network administrator or the like may not need to input information of standard average image-area ratio and recommended print page limit of printer to the automatic switching unit.

With the above-described configuration, an application of printer switching function can be set for each one of client machines. For example, some client machines may be set with printer switching function, and some client machines may not be set with printer switching function depending on specification and condition of client machines. For example, a client machine which issues print requests of classified documents frequently may be set as not-applicable of switching function, in which classified documents may be always output by a same one printer designated by the client machine to enhance print data security.

With the above-described configuration, a client user can temporarily cancel an application of printer switching function depending on use-environment of each of client machines, by which a network system adapted to client machine environment or network environment can be configured with various ways. For example, when a user wants to print a given image, which was printed in the past, with a same image quality, a client machine may temporarily cancel an application of switching function to use a same printer designated and used in the past. In such a case, image quality difference such as color tone difference among printed images in the past and present can be reduced or prevented. If different printers are used, image quality difference may more likely occur.

In the above-described exemplary embodiments, a computer can be used with a computer-readable program to control functional units used for an information processing system or apparatus. For example, a particular computer may control information processing apparatus used for the above described network system using a computer-readable program, which can execute the above-described processes or steps. Further, in the above-described exemplary embodiments, a storage device (or storage medium), which can store computer-readable program, may be a flexible disk, a compact disk read only memory (CD-ROM), a digital versatile disk read only memory (DVD-ROM), DVD recording only/rewritable (DVD-R/RW), a memory card, a memory chip, a mini disk (MD), magnetic tape, hard disk in a server, or the like, but not limited these. Further, a computer-readable program can be downloaded to a particular computer (e.g., personal computer) via a network, or a computer-readable program can be installed to a particular computer from the above-mentioned storage device, by which the particular computer may be used for the information processing system or apparatus according to exemplary embodiments, for example.

Numerous additional modifications and variations are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended claims.

What is claimed is:

1. A networked printer system, comprising:
one or more client machines disposed on a network;
a plurality of networked printers disposed on the network and connected to the one or more client machine via the network; and
an automatic switching unit disposed on the network, comprising:
a print request receiving unit receiving a print request issued by the client machine; and
a printer information acquisition unit obtaining and storing print history information of each one of the networked printers,
wherein the automatic switching unit determines one suitable printer from among the plurality of networked printers based on print data of the print request and the print history information of the networked printers, and transmits the print data issued by the client machine to the one suitable printer.

2. The networked printer system of claim 1, wherein the automatic switching unit attaches a printing-operation priority level to each networked printer based on the print history information when transmitting the print data and determines a printer having a higher printing-operation priority level and in ready-to-print condition as the one suitable printer.

3. The networked printer system of claim 1, wherein the print history information comprises an average image-area ratio of each one of networked printers.

4. The networked printer system of claim 3, wherein when the printer, connected to the network, has a plurality of image forming units, an actual average image-area ratio and a standard average image-area ratio set for each one of the image forming units are used to compute a printing-operation priority level of the printer.

5. The networked printer system of claim 3, wherein the standard average image-area ratio of each of the networked printers is set as an allowable range of average image-area ratio, and
when the number of printers, for which the actual average image-area ratio is out of the allowable range, exceeds a given proportion of a total number of networked printers connected to the network, the automatic switching unit is activated to determine the one suitable printer.

6. The networked printer system of claim 3, wherein when a printer is added to the network, the automatic switching unit automatically obtains a standard average image-area ratio set for the added printer.

7. The networked printer system of claim 1, wherein the print history information includes number of pages printed per predetermined unit of time.

8. The networked printer system of claim 7, wherein when the printer, connected to the network, has a plurality of image forming units, an actual number of printed pages and a recommended print page limit set for each one of the image forming units are used to compute a printing-operation priority level of the printer.

9. The networked printer system of claim 7, wherein the recommended print page limit of each of the networked printers is set as an allowable range of number of print page; and
when the number of printers, for which the actual number of printed pages is out of the allowable range, exceeds a given proportion of a total number of networked printers connected to the network, the automatic switching unit is activated to determine the one suitable printer.

10. The networked printer system of claim 7, wherein when a printer is added to the network, the automatic switching unit automatically obtains a recommended print page limit per predetermined unit of time set for the added printer.

11. The networked printer system of claim 1, wherein the print history information comprises an actual average image-area ratio and the number of printed pages per predetermined unit of time by each one of the networked printers.

12. The networked printer system of claim 11, wherein when a printer is added to the network, the automatic switching unit automatically obtains a standard average image-area ratio and a recommended print page limit printable per predetermined unit of time of the added printer.

13. The networked printer system of claim 1, wherein the automatic switching unit selectively applies a printer switching function used to determine the one suitable printer to the one or more client machines.

14. The networked printer system of claim 1, wherein the client machine supports application of the printer switching function conductable by the automatic switching unit to determine the one suitable printer and temporarily cancels an application of the printer switching function.

15. A method of selecting a printer in a networked printer system, the networked printer system including one or more client machines, a plurality of networked printers being connected to the one or more client machine via a network, and an automatic switching unit including a print request receiving unit and a printer information acquisition unit disposed on the network, the method comprising the steps of:
a) receiving a print request issued by the client machine by the print request receiving unit;
b) obtaining and storing print history information of each one of the networked printers by the printer information acquisition unit;
c) determining one suitable printer from among the networked printers by the automatic switching unit based on print data of the print request and the print history information of the networked printers; and
d) transmitting the print data of the print request issued by the client machine to the one suitable printer.

16. A computer-readable medium storing a program for selecting a printer in a networked printer system, the program comprising instructions that when executed by a computer cause the computer to execute the method of claim 15.

17. An automatic switching unit disposed on a networked printer system including a client machine, and a plurality of networked printers being connected to the client machine via a network, the automatic switching unit comprising:
a print request receiving unit receiving a print request issued by the client machine; and
a printer information acquisition unit obtaining and storing print history information of each one of the networked printers,
wherein the automatic switching unit determines one suitable printer from among the networked printers based on print data of the print request and the print history information of the networked printers and transmits the print data issued by the client machine to the one suitable printer.
